(19) United States
(12) Patent Application Publication
(10) Pub. No.: US 2004/0228509 A1
(43) Pub. Date: Nov. 18, 2004

(54) Automatic spacial identification of tissue implanted linear sources using medical imaging

(75) Inventors: Edward J. Holupka, Medway, MA (US); Paul M. Meskell, Boston, MA (US); Irving D. Kaplan, Dedham, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Beth Israel Deaconess Medical Center, Inc., Boston, MA (US)

(21) Appl. No.: 10/438,765

(22) Filed: May 15, 2003

(51) Int. Cl. G06K 9/00

(52) U.S. Cl. 382/128

(57) ABSTRACT

A method for automatically determining position and shape of linear line sources implanted in a tissue using any form of diagnostic imaging is presented. Transaxial images are obtained throughout the subject tissue and converted into a binary image set by simple thresholding. The binary image set is analyzed for contiguous regions of unit pixel value. An aspect ratio is computed for each contiguous region based on the geometric properties of the region. The linear line sources are detected based on the computed aspect ratios.

### BACKGROUND OF THE INVENTION

Brachytherapy is a well-established low dose, close-distance radiation for the treatment of cancer. Brachytherapy delivers more radiation to the diseased tissue than external-beam radiation and less dose to surrounding normal tissue. Radioactive sources are implanted individually into tissue, such as, the prostate, breast, liver, lung, uterus, bile duct or spleen to direct radiation to a lesion such as a tumor. The radioactive sources deliver a high dose of radiation to the implanted tissue. The radioactive sources are permanently implanted. Palladium 103 is one such permanently implantable radioactive source used in Brachytherapy.

The prostate is located adjacent to the urethra and rectum. Brachytherapy maximizes the radiation to be delivered to the diseased prostate and minimizes the radiation to the healthy urethra and rectum. The standard procedure for radioactive source implantation in the prostate involves the placement of radioactive sources directly into the prostate gland using transperineal needles that are loaded with a specific radioactive source pattern. The radioactive source pattern is termed the “pre-plan” and is determined before the operating room procedure. Briefly, transrectal ultrasound or CAT scan is used to determine the volume and contour of the prostate gland. Dose distribution is determined based on measurement of target volume. The placement determined by the pre-plan is optimized so that the entire prostate is receiving a tumorcidal dose while healthy tissue such as the urethra and rectum surrounding the prostate gland receives minimum exposure to radiation.

The radioactive sources are implanted into the prostate gland under transrectal ultrasound guidance. The placement of the radioactive sources is dependent on the texture of the prostate gland tissue and swelling that may not have been present when the pre-plan was performed. Thus, the desired dose distribution throughout the prostate gland can be significantly different than the actual dose distribution because the radioactive sources may not be placed exactly as planned according to the pre-plan.

### SUMMARY OF THE INVENTION

The determination of the actual dose distribution delivered to the prostate gland is termed the “post-plan”. The post-plan is conventionally based on a CAT scan performed outside the operating room, sometimes weeks after the operating room procedure. If the resultant dose distribution is inadequate, the patient has the option of undergoing the brachytherapy procedure again to add more radioactive sources to the prostate gland or to undergo a salvage prostatectomy.

According to the present invention, the post-plan is performed in the operating room immediately following the brachytherapy procedure allowing corrective action to be taken before the patient leaves the operating room. The dose distribution can be progressively modified with the addition of implants until the dose distribution results in an optimal, very positive outcome for the patient before the patient leaves the operating room.

In the present invention, computer implemented method and apparatus automatically identifies an implant in subject tissue. Transaxial images of the subject tissue are obtained. The transaxial images are converted into a binary image set using a thresholding filter. Each binary image is analyzed for contiguous regions of unit pixel value. An aspect ratio for each contiguous region is computed based on geometric properties of each contiguous region, and a contiguous region corresponding to the implant is determined based on the computed aspect ratios.

The aspect ratio is computed by (i) evaluating the moment of inertia tensor for each contiguous region, (ii) evaluating at least three eigenvectors and corresponding eigenvalues using the moment of inertia tensor expressed in the diagonal for the contiguous region, and (iii) determining aspect ratio based on the eigenvalues. In one embodiment, the contiguous region with the largest computed aspect ratio corresponds to the implant.

According to one embodiment, the transaxial images may be parallel to and equal distance from each other.

In accordance with one aspect of the present invention. The length of the implant is much greater than the width.

In accordance with another aspect of the present invention, the implant is a brachytherapy device which may be a radioactive coiled wire or a radioactive seed. The outer diameter of the radioactive coiled wire is between about 25 micrometers and about 1000 micrometers. The length of the radioactive coiled wire is between 1 centimeter and 6 centimeters. The aspect ratio of the implant ranges from 1:14 to 1:171.

The transaxial images may be obtained using ultrasound, CAT scan or magnetic resonance imaging.

The subject tissue is a relatively soft tissue and may be a prostate gland.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a method for implanting radioactive sources in a prostate gland;

FIG. 2 illustrates one embodiment of a radioactive source implanted in the prostate through the needle as shown in FIG. 1;

FIG. 3 illustrates another embodiment of a radioactive source inserted through the needle as shown in FIG. 1;

FIG. 4 is a computer system including an implant identifier routine according to the principles of the present invention;

FIG. 5 illustrates an array of transaxial images obtained throughout an example prostate gland;

FIG. 6 is a flow chart illustrating the method for identifying the implants implemented in the implant identifier routine shown in FIG. 4;

FIG. 7A illustrates one of the 2-D grey scale transaxial images;

FIG. 7B illustrates the 2-D binary image produced from the 2-D grey scale transaxial image shown in FIG. 7A;

FIG. 7C illustrates blobs detected in the 2-D binary image shown in FIG. 7B;

FIG. 8 illustrates a blob to be analyzed; and

FIG. 9 illustrates the axes for a contiguous region.

### DETAILED DESCRIPTION OF THE INVENTION

A description of preferred embodiments of the invention follows.

FIG. 1 illustrates a method for implanting radioactive sources 102 in a prostate gland 100. A needle template 104 is positioned in front of the prostate dependent on a pre-plan performed prior to surgery. The needle template 104 has a plurality of holes 101 through which to insert a needle 106 having at least one radioactive source 102 to be implanted into the prostate 100. The radioactive sources 102 in the needle 106 are spaced apart according to the pre-plan. The needle 106 with the radioactive sources 102 is placed at each hole 101 through which the radioactive sources 102 are to be inserted. The radioactive sources 102 are inserted into the prostrate 100 in the predetermined order.

The pre-plan assumes that the radioactive sources 102 will be inserted in a straight line into the prostate 100 and that the radioactive devices 102 remain in a straight line after they are inserted. However, if any of the radioactive sources 102 moves, there may be a cold spot in the prostate 100 in which the cancer cells will not be killed.

FIG. 2 illustrates one embodiment of the radioactive source 102 implanted in the prostrate 100 through the needle 106 as shown in FIG. 1. The radioactive source 102 is a radioactive sealed source seed. The radioactive seed is similar in size to a grain of rice with a typical diameter of about 0.81 millimeter (“mm”) and length of about 4.5 mm. In that case, the needle 106 has a medium bore of about 18-gage. The aspect ratio of a radioactive source is the ratio of width to height. The aspect ratio of a radioactive seed is thus computed by dividing the length (as the “width”) by the diameter (as the “height”). The length of the radioactive seed is greater than the diameter which produces an aspect ratio of 4.5/0.81=1:5.5.

FIG. 3 illustrates another example of a radioactive source 102 inserted through the needle 106 shown in FIG. 1. The illustrated radioactive source 102 is a Palladium-103 activated linear coil. The linear coil can be cut to custom lengths to facilitate the generation of optimal treatment plans in the operating room. The linear coil is implanted directly into the prostate 100 in much the same fashion as conventional seed implantation as shown in FIG. 1. The linear coil has approximate dimensions of 0.35 mm in diameter, a pitch of 40 turns per centimeter and a typical “coiled” length of about 5 mm to 60 mm. The aspect ratio ranges from 1:14 to 1:171.4. The minimum length of the linear coil is dependent on the nature of artifacts within an average ultrasound image of the implanted tissue. For example, in a prostate gland, these artifacts are typically less than 10 mm in length. Thus, the linear coils implanted in the prostate gland are typically greater than 10 mm in length. The diameter of the linear coil is smaller than that of the radioactive seed and thus can be inserted using a needle with a smaller bore.

It is understood that other radioactive sources 102 in addition to the illustrated seeds (FIG. 2) and linear coil (FIG. 3) are suitable for the present invention. The radioactive seeds and linear coil of FIGS. 2 and 3 are mentioned for purposes of illustration and not limitation.

Once implanted in the prostate, the radioactive sources 102 can be visualized using ultrasound flouroscopic imaging, CAT scan, magnetic resonance imaging, or other imaging techniques well-known to those skilled in the art.

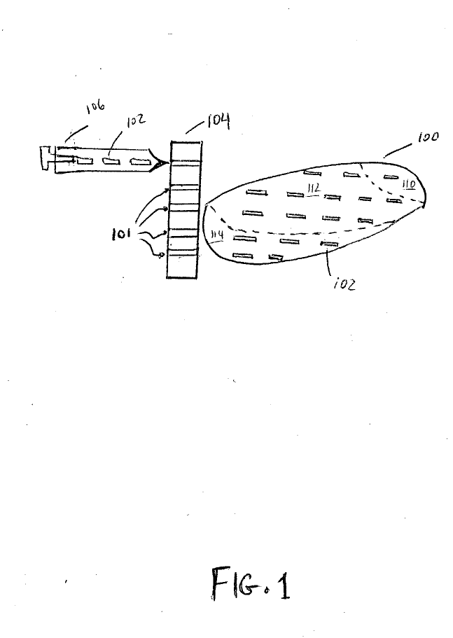

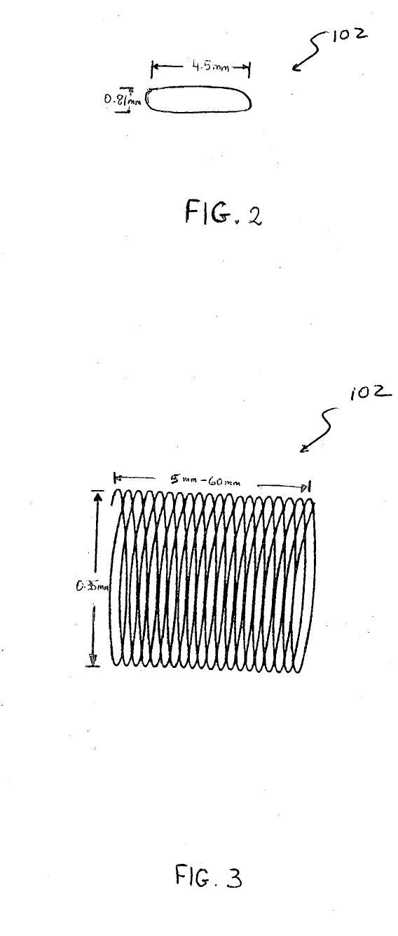

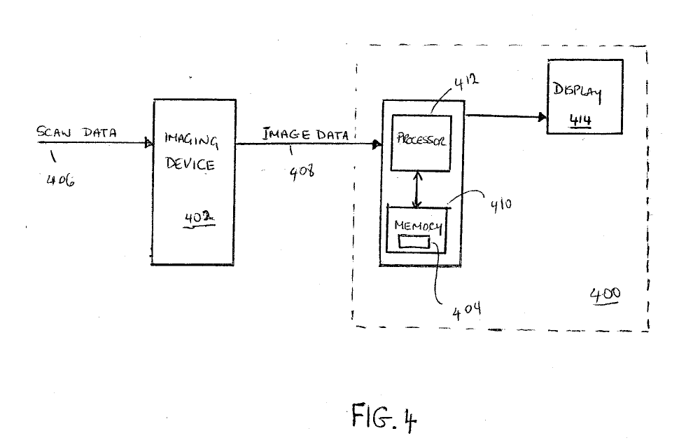

FIG. 4 is a computer system 400 including an implant identifier routine 404 according to the principles of the present invention. An implant is an item or element implanted in tissue. Tissue is an aggregate of cells of a particular kind together with their intercellular substance that forms one of the structural materials of an animal. In the embodiment discussed in FIG. 4, the implant is a radioactive source 102 which is implanted in a prostate gland. Other implantable elements and other tissue are suitable for practicing the present invention. Continuing with the example of FIG. 4, transaxial images are obtained throughout the prostate from scan data 406 received by an imaging device 402. In the embodiment shown, the imaging device 402 obtains images 408 using ultrasound. The scan data 406 is based on echoes received in response to sound waves transmitted through a transducer probe (not shown) applied to the patient's body. The image data 408 is stored in memory 410 and processed by a processor 412. Each transaxial ultrasound image 408 defines the prostate (subject tissue) and also displays all calcifications, artifacts and implants in the prostate responding to the ultrasound. An implant identifier routine 404 stored in memory 410 and executed by processor 412 identifies implants in the prostate based on the received image data 408. Output of implant identifier routine 404 is provided to other computer routines of processor 412, other computer modules and the like (for example, for dose calculation). Processor 412 may provide output through display means (a monitor) 414 and the like.

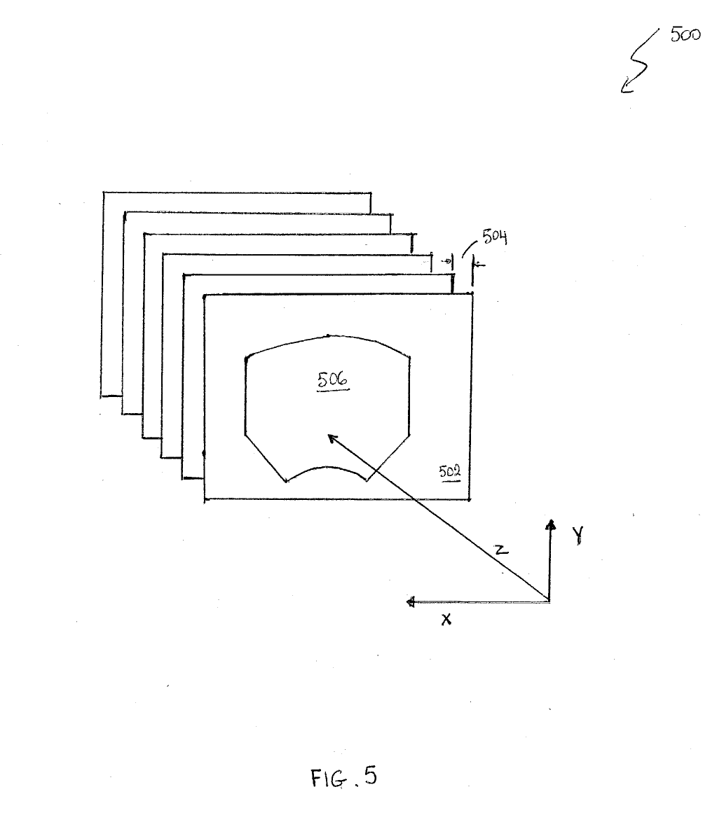

FIG. 5 illustrates an array of transaxial images 500 obtained throughout the prostate 506. Each image 502 is a 2-Dimensional (2-D) image or slice of the 3-D object (the prostate). In the embodiment shown, the transaxial images 500 have parallel image normals and constant spacing. These transaxial images 500 are used to define the 3-D object. Each image or slice includes a set of 2-D picture elements (pixels) having an x and y component. The distance between consecutive slices represents depth and roughly corresponds to location along the z axis. The depth between two slices is referred to as the interslice distance 504. In one embodiment, the transaxial images are obtained at 2.5 mm interslice distance. However, it is not necessary that the transaxial images have parallel image normals or constant spacing. The set of transaxial images are combined into a three-dimensional image set. A depth dimension (z) is added to each pixel, that is, the pixels become voxels (3-Dimensional pixels).

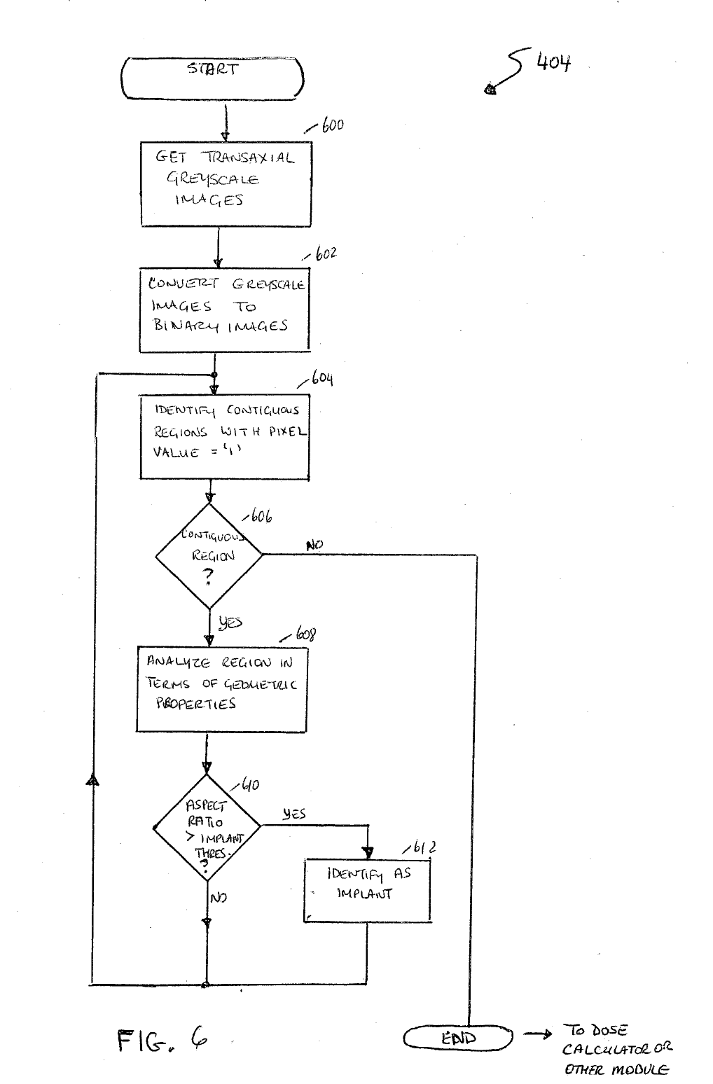

FIG. 6 is a flowchart illustrating the method for identifying implants implemented in the implant identifier routine 404 shown in FIG. 4. The method reads in an image set 500 (FIG. 5) and based on user defined values for an implant threshold ratio and a detected artifact threshold ratio, identifies the position and shape of implanted linear artifacts.

At step 600, the transaxial images 500 shown in FIG. 5 obtained using ultrasound define a three-dimensional imaging volume Iᵢⱼₖ where Iᵢⱼₖ specifies the ultrasound response of a voxel located at \vec{r}ᵢⱼₖ.

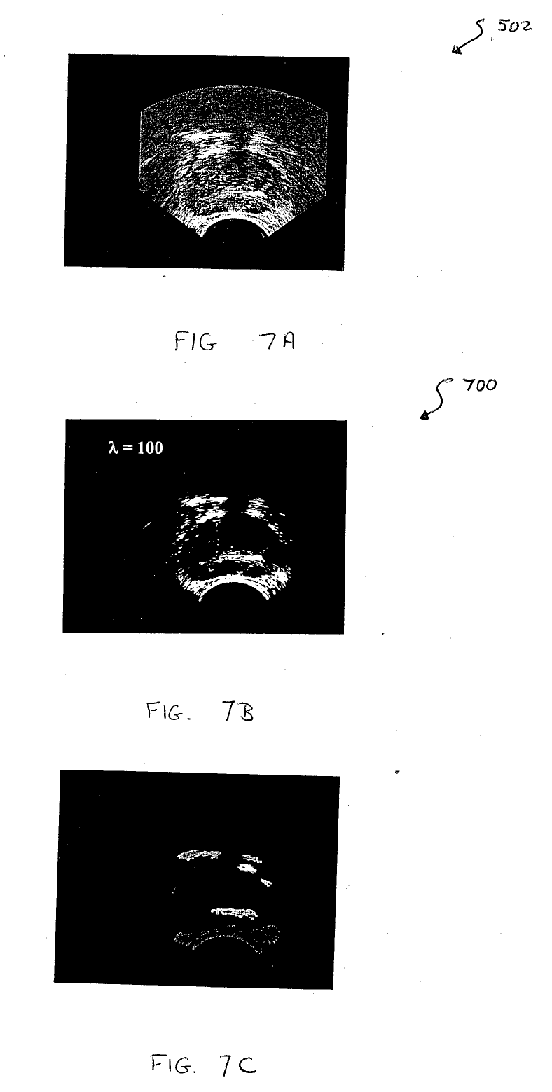

FIG. 7A illustrates one of the 2-D grey scale transaxial images 502. Each voxel has an assigned grey scale value. Returning to FIG. 6, at step 602, the transaxial ultrasound images 500, 502 converted into a binary image set by simple thresholding. A thresholding filter is defined such that if a given voxel in the ultrasound imaging volume is greater than a detected artifact threshold λ, the value of the voxel is set equal to one, otherwise it is set to zero. Mathematically, the thresholding filter converts grey scale image Iᵢⱼₖ to binary image I′ᵢⱼₖ based on a defined threshold.

$${I}_{ijk}^{′} = \{ \begin{matrix}1 & {I}_{ijk} \geq λ \\ 0 & {I}_{ijk} < λ\end{matrix}$$

For example, for a gray scale image with pixels assigned gray scale values from 0-255, the detected artifact threshold λ is 100. Thus, gray scale values 0-99, are mapped to ‘0’ (white) and gray scale values 100-255 are mapped to ‘1’ (black). In the image for the linear coil shown in FIG. 3, the detected artifact threshold λ value is 100.

Thresholding of the ultrasound images 500 results in binary images parameterized by the detected artifact threshold λ. FIG. 7B illustrates the 2-D binary image 700 produced from the 2-D grey scale image 502 shown in FIG. 7A. The 2-D binary image 700 includes a plurality of contiguous regions of unit voxels. A contiguous region of unit voxels is referred to as a ‘blob’. A blob is an island of unit pixel value (‘1’) within the imaging volume. Blobs vary in size and shape dependent on the detected artifact threshold and the tissue that is imaged.

Returning to FIG. 6, at step 604, once the set of 2-D binary images is constructed, each 2-D binary image 700 is analyzed for contiguous regions of unit pixel value; a “blob”. Preferrably, there is no minimum blob size. A blob can be just one voxel. All blobs are analyzed. FIG. 7C illustrates ‘blobs’ detected in the 2-D binary image 700 shown in FIG. 7B.

Returning to FIG. 6, at step 606, a ‘blob’ is selected for analysis. If there is a blob to analyze, processing continues with step 608. If not, processing is complete.

At step 608, each blob is analyzed in terms of its geometric properties. The shape of an implant differs from other artifacts detected by the imaging system 402. The implant can be distinguished from other detected artifacts by analyzing the geometric properties of each ‘blob’.

The first geometric property computed is the “moment of inertia” tensor, which is the spatial makeup of the ‘blob’. The moment of inertia of a plane surface with respect to an axis is the sum of the products obtained by multiplying the area of each element of the surface by the square of its distance from the axis. The “moment of inertia” tensor is calculated for each blob.

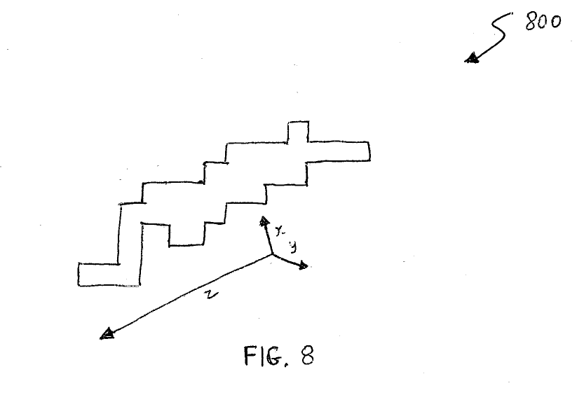

FIG. 8 illustrates a ‘blob’ 800 to be analyzed. As shown, one of the axes of the ‘blob’ 800 is much longer than the others. Thus, the blob 800 has an overall linear shape. The “moment of inertia” tensor for the i^{th} blob in the 3-D imaging volume is computed by summing the product of the three spatial indices (x, y, z) for all the voxels in the ith blob.

$${I}_{μ v}^{( i )} = \frac{1}{N} {\sum }_{j = 1}^{{N}_{i}} {X}_{i , μ}^{j} \cdot {X}_{i , v}^{j}$$

where:

Nᵢ is the number of voxels in the i^{th} blob.

j iterates through the voxels in the i^{th} blob.

μand ν run over the three spatial indices (1, 2, 3) where:

X_{i,1}^{j}=X_{i,2}^{j},=γᵢ^{j},X_{i,3}^{j}=Zᵢ^{j} are the coordinates of the j^{th} voxel of the iₜₕ blob.

I_{82 ν}⁽ⁱ⁾ is the moment of inertia of the i^{th} blob.

Returning to FIG. 6 (step 608), any tensor can be represented as a principal axis frame by diagonalizing, that is by using xx, yy, zz terms only. The moment of inertia tensor for each blob is diagonalized and hence cast in the principal axis frame. The moment of inertia is used to determine the eigenvectors and eigenvalues for each blob.

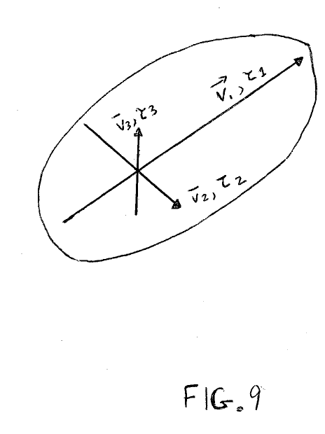

FIG. 9 illustrates the axes for a contiguous region. Each axis has an associated eigenvector (\vec{V}) and eigenvalue (τ). The eigenvectors and eigenvalues are determined by solving the following set of simultaneous linear equations:

$${I}_{μ v}^{( i )} \cdot {V}_{v , σ}^{( i )} = {τ}_{σ}^{( i )} {V}_{v , σ}^{( i )} ,$$

where \vec{V}_{σ}⁽ⁱ⁾ and τ_{σ}⁽ⁱ⁾ are the set of eigenvectors and corresponding eigenvalues, respectively, for the ith blob.

All subscript indices (μ, v, σ) range from 1-3.

Next in step 608 (FIG. 6) the aspect ratio is computed for each blob as follows:

$${Γ}^{( i )} = \frac{{τ}_{>}^{( i )}}{{τ}_{<}^{( i )}} ⅇ$$

where: τ_{>}⁽ⁱ⁾ is the largest of the three eigenvectors for the i^{th} blob.

σ_{<}⁽ⁱ⁾ is the smallest of the three eigenvectors for the i^{th} blob.

Returning to FIG. 6, at step 610, the computed aspect ratio is compared with an implant threshold value as follows:

Γ⁽ⁱ⁾>Γ_{c}

where: Γ⁽ⁱ⁾ is the computed aspect ratio of the blob; and

Γ_{c} is the implant threshold value.

If the blob has an aspect ratio greater than the implant threshold value, processing continues with step 612. If not, processing continues with step 604 to analyze the next blob.

At step 612, the blob is identified as an implant. Processing continues with step 604 to determine if the next blob is an implant.

All implants have an aspect ratio which is greater than the implant threshold value Γ_{c}. For example, the radioactive coil 102 (FIG. 3) with length ranging from 1 cm to 6 cm and diameter of about 0.035 cm from Radiomed has an aspect ratio ranging from 1:28.6 to 1:171.4 Similarly, the radioactive seed 102 (FIG. 2) with length of 4.5 mm and diameter of 0.81 mm has an aspect ratio of 1:5.5 which can be selected as the implant threshold value Γ_{c}.

To distinguish between other artifacts in the prostate gland or subject tissue, the length of the radioactive source must be longer than other artifacts. Typically, artifacts in the prostate gland have a length less than 1.0 cm. Thus, the length of the radioactive coil is selected to be at least 1.0 cm so that it can be distinguished from other artifacts in the prostate gland. The radioactive seed with maximum length of 4.5 mm cannot be distinguished from other artifacts in the prostate gland but is distinguishable in other implanted tissue having artifacts with length less than 4.5 mm.

In the preferred embodiment, after the implants have been identified by the invention implant identifier routine 404, area location of the identified implants is determined.

After the location of the implants in the prostate have been identified, the actual dose can be computed based on a dose of approximately 1 milli Curie per centimeter. One or more implants can be added to an area until the ideal dose is provided.

The method has been described for identifying implants in the prostate. However, the invention is not limited to identifying implants in the prostrate. The invention can be used to identify any generally or effectively linear implant in any tissue. The method for automatically identifying implants has been described using ultrasound images. However, the method is not limited to ultrasound images. The method can also be implemented using images obtained using CAT scan, Magnetic Resonance Imaging (MRI) or any other method for providing an image of implanted tissue.

While this invention has been particularly shown and described with references to preferred embodiments thereof, it will be understood by those skilled in the art that various changes in form and details may be made therein without departing from the scope of the invention encompassed by the appended claims.

For example, the foregoing describes the invention method (FIG. 6) and computer routine 404 (FIG. 4) as being executed by a digital processor 412. It is understood that a network or plurality of processors may be used. Likewise parallel processing may be used. The input image data 408 (FIG. 4) may be transmitted over a network (local area, global or otherwise) or downloaded from one or multiple imaging devices 402 (FIG. 4) of the same or different types. Such other configurations of processors 412 and/or imaging devices 402 are within the purview of one skilled in the art.

What is claimed is:

1. A computer implemented method for automatically identifying an implant in subject tissue comprising the steps of:
obtaining transaxial images of the subject tissue;
converting the transaxial images into a binary image set using a thresholding filter;
analyzing each binary image for contiguous regions of unit pixel value;
computing an aspect ratio for each contiguous region based on geometric properties of each contiguous region; and
determining which contiguous region corresponds to the implant based on the computed aspect ratios.

2. The method as claimed in claim 1 wherein the step of computing further comprises:
evaluating the moment of inertia tensor for each contiguous region;
evaluating at least three eigenvectors and corresponding eigenvalues using the moment of inertia tensor expressed in the diagonal for the contiguous region; and
determining aspect ratio based on the eigenvalues.

3. The method as claimed in claim 1 wherein the contiguous region with the largest computed aspect ratio corresponds to the implant.

4. The method as claimed in claim 1 wherein the transaxial images are parallel to and equal distance from each other.

5. The method as claimed in claim 1 wherein the length of the implant is much greater than the width.

6. The method as claimed in claim 1 wherein the implant is a brachytherapy device.

7. The method as claimed in claim 6 wherein the brachytherapy device is a radioactive coiled wire.

8. The method as claimed in claim 7 wherein the outer diameter of the radioactive coiled wire is between about 25 micrometers and about 1000 micrometers.

9. The method as claimed in claim 8 wherein the length of the radioactive coiled wire is between 1 centimeter and 6 centimeters.

10. The method as claimed in claim 6 wherein the aspect ratio of the implant ranges from 1:14 to 1:171.

11. The method as claimed in claim 6 wherein the brachytherapy device is a radioactive seed.

12. The method as claimed in claim 1 wherein the transaxial images are obtained using ultrasound.

13. The method as claimed in claim 1 wherein the transaxial images are obtained using CAT scan.

14. The method as claimed in claim 1 wherein the transaxial images are obtained using magnetic resonance imaging.

15. The method as claimed in claim 1 wherein the subject tissue is relatively soft.

16. The method as claimed in claim 15 wherein the subject tissue is a prostate gland.

17. A system for automatically identifying an implant in subject tissue comprising:
an imaging device which obtains transaxial images of the subject tissue; and
an implant identifier routine executed in a computing device coupled to the imaging device which (i) converts the transaxial images into a binary image set using a thresholding filter, (ii) analyzes each binary image for contiguous regions of unit pixel value, (iii) computes an aspect ratio for each contiguous region based on geometric properties of each contiguous region, and (iv) determines which contiguous region corresponds to the implant based on the computed aspect ratios.

18. The system as claimed in claim 17 wherein the implant identifier routine computes the aspect ratio by (a) evaluating the moment of inertia tensor for each contiguous region, (b) evaluating at least three eigenvectors and corresponding eigenvalues using the moment of inertia tensor expressed in the diagonal for the contiguous region, and (c) determining aspect ratio based on the eigenvalues.

19. The system as claimed in claim 17 wherein the contiguous region with the largest computed aspect ratio corresponds to the implant.

20. The system as claimed in claim 17 wherein the transaxial images are parallel to and equal distance from each other.

21. The system as claimed in claim 17 wherein the length of the implant is much greater than the width.

22. The system as claimed in claim 17 wherein the implant is a brachytherapy device.

23. The system as claimed in claim 22 wherein the brachytherapy device is a radioactive coiled wire.

24. The system as claimed in claim 23 wherein the outer diameter of the radioactive coiled wire is between about 25 micrometers and about 1000 micrometers.

25. The system as claimed in claim 24 wherein the length of the radioactive coiled wire is between 1 centimeter and 6 centimeters.

26. The system as claimed in claim 25 wherein the aspect ratio of the implant ranges from 1:14 to 1:171.

27. The system as claimed in claim 22 wherein the brachytherapy device is a radioactive seed.

28. The system as claimed in claim 17 wherein the imaging device obtains the images using ultrasound.

29. The system as claimed in claim 17 wherein the imaging device obtains the images using CAT scan.

30. The system as claimed in claim 17 wherein the imaging device obtains the images using magnetic resonance imaging.

31. The system as claimed in claim 17 wherein the subject tissue is relatively soft.

32. The system as claimed in claim 31 wherein the subject tissue is a prostate gland.

33. Apparatus for automatically identifying an implant in subject tissue comprising:
(a) means for receiving transaxial images of the subject tissue; and
(b) computer means for identifying an implant, the computer means responsive to the means for receiving transaxial images and in response, (i) converting the transaxial images into a binary image set using a thresholding filter, (ii) analyzing each binary image for contiguous regions of unit pixel value, (iii) computing an aspect ratio for each contiguous region based on geometric properties of each contiguous region, and (iv) determining which contiguous region corresponds to the implant based on the computed aspect ratios.
